(19) United States
(12) Patent Application Publication
(10) Pub. No.: US 2022/0318108 A1
(43) Pub. Date: Oct. 6, 2022

(54) COMPOUND STORAGE SYSTEM AND CONTROL METHOD FOR COMPOUND STORAGE SYSTEM

(71) Applicant: Hitachi, Ltd., Tokyo (JP)

(72) Inventors: Akira YAMAMOTO, Tokyo (JP); Hiroto EBARA, Tokyo (JP); Yoshinori OHIRA, Tokyo (JP)

(73) Assignee: Hitachi, Ltd.

(21) Appl. No.: 17/469,740

(22) Filed: Sep. 8, 2021

(30) Foreign Application Priority Data
Mar. 30, 2021 (JP) 2021-057229

(51) Int. Cl. G06F 11/20; G06F 3/06

(52) U.S. Cl. CPC G06F 11/2094; G06F 3/0619; G06F 3/0644; G06F 3/0659; G06F 3/0683; G06F 3/0665; G06F 2201/85

(57) ABSTRACT

A compound storage system includes a plurality of storage boxes each having a plurality of storage units, and a plurality of real storage systems that process data inputted/outputted to/from the storage units. When a failure occurs at a storage unit 160, the real storage system 100 having the control right executes the recovery process of recovering data stored in a storage area allocated to a logical volume, and the real storage system 100 having the allocation authority executes the recovery process of recovering data stored in a storage area not allocated to the logical volume.

### BACKGROUND OF THE INVENTION

### 1. Field of the Invention

The present disclosure relates to a compound storage system and a control method therefor.

### 2. Description of the Related Art

Japanese Patent No. 6114397 discloses a compound storage system in which a plurality of storage boxes housing a plurality of storage units are shared by a plurality of storage systems. According to this compound storage system, load balancing between the storage systems is carried out by allocating a control right, which is an authority to read/write data from/to a logical volume, to one of the storage systems. When a new storage system is added, the control right over the logical volume is transferred from an existing controller to a newly added controller. When a new storage box is added, a storage system is determined, the storage system having an allocation authority to allocate the storage area of a storage unit included in the newly added storage box to the logical volume.

The compound storage system described in Japanese Patent No. 6114397 supports a capacity virtualization function of virtualizing the capacity of a storage unit. The capacity virtualization function is referred to as thin provisioning, and is described also, for example, in Japanese Patent No. 4369520.

The capacity virtualization function manages storage areas in units called pages. Specifically, logical volumes are managed in units called virtual pages, and the storage areas of actual storage units are managed in units called real pages. In a stage where a logical volume has been defined, allocation of a real page to a virtual page is not carried out, and when write data is written to a storage unit, a real page including an area to which the write data is written is allocated to a virtual page. Because of this procedure, precise calculation of the capacity of a logical volume is unnecessary and defining a relatively large capacity is enough. Management cost, therefore, can be reduced.

According to the compound storage system described in Japanese Patent No. 6114397, the allocation authority to allocate a real page to a virtual page is allocated to one of the storage systems.

### SUMMARY OF THE INVENTION

However, Japanese Patent No. 6114397 does not disclose a technique by which, when a failure occurs at a storage unit in the compound storage system, data stored in the storage unit is recovered.

An object of the present disclosure is to provide a compound storage system and a control method therefor that when a plurality of storage systems share storage units of a plurality of storage boxes, allow recovery of data stored in a storage unit having a failure occurred.

A compound storage system according to one aspect of the present disclosure includes: a plurality of storage units; and a plurality of storage systems each of which provides a logical volume, the storage system processing data inputted to and outputted from the storage units, via the logical volume. In the compound storage system, a storage area of each of the storage units is allocated to the logical volume, a control right that is an authority to input and output data to and from the logical volume is allocated to one of the storage systems, and an allocation authority that is an authority to allocate the storage area of the storage unit to the logical volume is allocated to one of the storage systems. When a failure occurs at the storage unit, a storage system having the control right executes a recovery process of recovering data stored in the storage area allocated to the logical volume, while a storage system having the allocation authority executes a recovery process of recovering data stored in the storage area not allocated to the logical volume.

According to the present disclosure, when a plurality of storage systems share a plurality of storage units, data stored in a storage unit having a failure occurred can be recovered.

### BRIEF DESCRIPTION OF THE DRAWINGS

FIG. 1 depicts a configuration of an information system according to a first embodiment of the present disclosure;

FIG. 2 depicts an example of server port information;

FIG. 3 depicts an example of a configuration of a real storage system;

FIG. 4 depicts an example of a configuration of a cache;

FIG. 5 depicts an example of information stored in a common memory;

FIG. 6 depicts an example of storage system information;

FIG. 7 depicts an example of other storage systems information;

FIG. 8 depicts an example of virtual logical volume information;

FIG. 9 depicts an example of logical volume information;

FIG. 10 depicts an example of storage box information;

FIG. 11 depicts an example of spare unit information;

FIG. 12 depicts an example of storage group information;

FIG. 13 depicts an example of real page information;

FIG. 14 depicts an example of storage unit information;

FIG. 15 depicts an example of cache management information;

FIG. 16 is a diagram for explaining an empty cache management information pointer;

FIG. 17 is a diagram for explaining an empty real page information pointer in detail;

FIG. 18 depicts a functional configuration created by executing a program;

FIG. 19 is a flowchart for explaining an example of a spare initializing process;

FIG. 20 is a flowchart for explaining an example of a return initializing process;

FIG. 21 is a flowchart for explaining an example of a read process;

FIG. 22 is a flowchart for explaining an example of a write request receiving process;

FIG. 23 is a flowchart for explaining an example of a write-after process;

FIG. 24 is a flowchart for explaining an example of a spare data area recovery process;

FIG. 25 is a flowchart for explaining an example of a data area returning process;

FIG. 26 is a flowchart for explaining an example of a spare empty area recovery process;

FIG. 27 is a flowchart for explaining an example of an empty area returning process;

FIG. 28 depicts a configuration of an information system according to a second embodiment of the present disclosure; and

FIG. 29 depicts an example of a memory resource used by a control virtual machine (VM).

### DESCRIPTION OF THE PREFERRED EMBODIMENTS

Embodiments of the present disclosure will now be described with reference to the drawings.

### First Embodiment

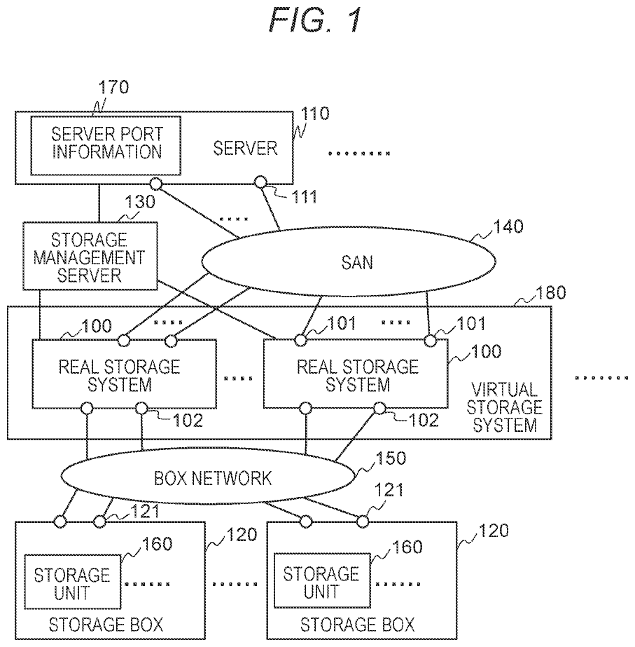

FIG. 1 depicts a configuration of an information system according to a first embodiment of the present disclosure. The information system shown in FIG. 1 is a compound storage system including one or more real storage systems 100, one or more servers 110, one or more storage boxes 120, and a storage management server 130.

The real storage systems 100 and the servers 110 are interconnected via a storage area network (SAN) 140, and the real storage systems 100 and the storage boxes 120 are interconnected via a box network 150. Specifically, the real storage systems 100 are connected to the SAN 140 through storage ports 101, and the servers 110 are connected to the SAN 140 through server ports 111. The real storage systems 100 are connected to the box network 150 through back-end ports 102, and the storage boxes 120 are connected to the box network 150 through box ports 121.

Each real storage system 100 is a system that processes data inputted/outputted to/from each storage box 120 (specifically, a storage unit 160, which will be described later) via a logical volume, which will be described later. The server 110 is a system run by a user application program, and transmits and receives data to and from the real storage system 100 via the SAN 140. The real storage systems 100 can mutually transmit and receive data via the SAN 140. In the SAN 140, a protocol allowing transfer of a small computer system interface (SCSI) command (e.g., Fiber Channel or the like) is used.

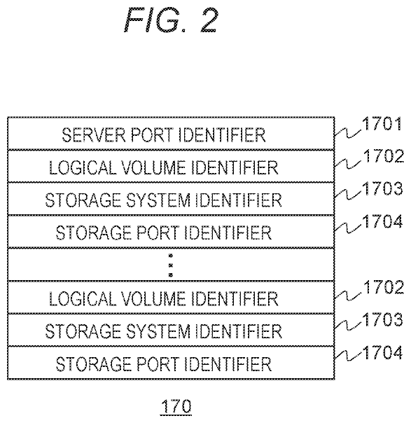

In the present embodiment, one or more real storage systems 100 make up a virtual storage system 180, which is a virtually configured storage system. In this case, the server 110 recognizes the virtual storage system 180 as a storage system that reads and writes data. The virtual storage system 180, however, may be not provided. In such a case, the server 110 recognizes the real storage system 100 as a storage system. In both cases, the server 110 has server port information 170 (see FIG. 2) for requesting the storage system to read and write data.

The storage box 120 includes one or more storage units 160 that store data. Each storage unit 160 is, for example, a storage device having a hard disk drive (HDD), a flash memory, or the like, as a storage medium. The flash memory may be a single-level-cell (SLC) memory or a multi-level-cell (MLC) memory. The storage medium is not limited to these examples, and may be, for example, a different storage medium, such as a phase change memory.

The storage box 120 is shared by real storage systems 100 via the box network 150, and the storage unit 160 in the storage box 120 is shared by real storage systems 100. The storage box 120 is connected to one or more real storage systems 100 in the virtual storage system 180, via the box network 150. The storage box 120 does not need to be connected to all the real storage systems 100 in the virtual storage system 180. Likewise, a set of storage boxes 120 connected to a certain real storage system 100 does not need to be identical to a set of storage boxes 120 connected to a different real storage system 100.

The storage management server 130 is a device for managing the real storage systems 100 and the storage boxes 120, and is used by, for example, a storage administrator who administrates this information system. The storage management server 130 is connected to the real storage systems 100 and the server 110 via a network (not illustrated) or the like.

In the present embodiment, the real storage system 100 has a capacity virtualization (thin provisioning) function. According to the capacity virtualization function, a storage area for storing data in a storage group including storage units 160 is secured as a capacity pool, and this capacity pool is managed in units called pages (real pages). In a stage where a logical volume has been defined, allocation of a storage area to the logical volume is not carried out. When a write request is issued, a real page corresponding to a storage area for storing write data to be written according to the write request is allocated to a virtual page that is a partial space of the logical volume. Such a virtually functioning logical volume corresponding to the capacity virtualization function may be referred to as a virtual logical volume. The capacity of the virtual logical volume is larger than the capacity of the real storage area, and therefore the number of virtual pages is greater than the number of real pages.

FIG. 2 depicts an example of server port information 170. The server port information 170 is set for each server port 111.

The server port information 170 includes a server port identifier 1701 for identifying the server port 111, a logical volume identifier 1702 for identifying one or more logical volumes accessible through the server port 111, a storage system identifier 1703 for identifying a storage system having the logical volume, and a storage path identifier 1704 for identifying a storage path leading from the server 110 to the logical volume. The logical volume identifier 1702, the storage system identifier 1703, and the storage path identifier 1704 are set for each logical volume accessible through the server port 111. When a plurality of storage paths allowing access to one logical volume are present, a plurality of storage path identifiers 1704 are provided for one logical volume identifier 1702.

In the present embodiment, a storage system having logical volumes is defined as the virtual storage system 180. The storage system identifier 1703 is, therefore, an identifier for identifying the virtual storage system 180. When the virtual storage system 180 is not configured, however, the storage system identifier 1703 is an identifier for identifying the real storage system 100. The logical volume identifier 1702 is an identifier for identifying a virtual logical volume. When the virtual storage system 180 is not configured, however, the logical volume identifier 1702 is an identifier for identifying the logical volume of the real storage system 100. The identifier for the virtual logical volume is a unique value in the virtual storage system 180. Because each real storage system 100 has a logical volume, the identifier of the logical volume is a unique value in the real storage system 100.

A read/write request (read request and write request) issued by the server 110 includes the logical volume identifier 1702, the storage system identifier 1703, and the storage path identifier 1704. Since the storage path identifier 1704 identifies not a virtual path but a real storage path, the read/write request indicates the real storage system 100 that receives the read/write request.

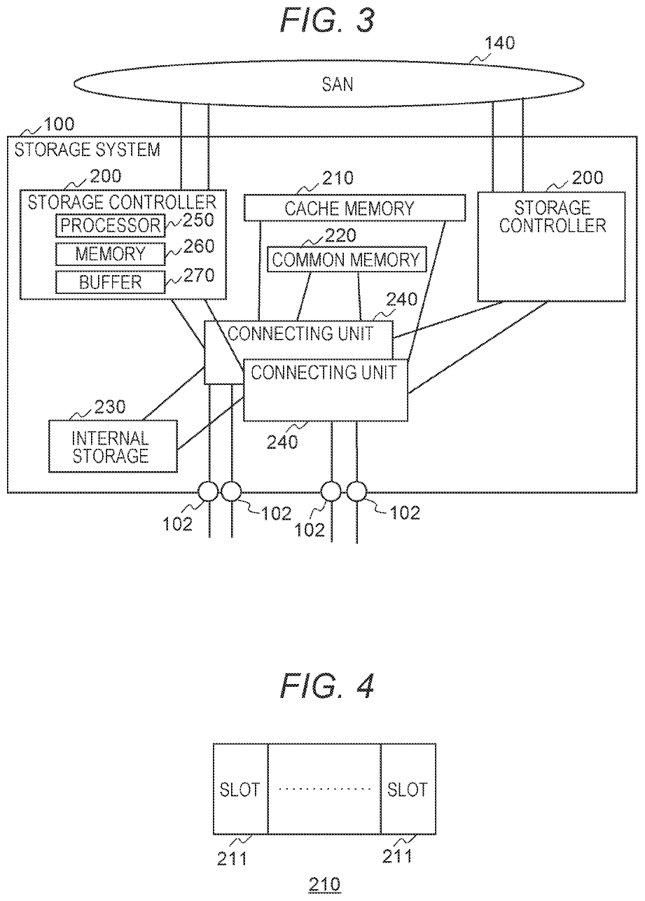

FIG. 3 depicts an example of a configuration of the real storage system 100. The real storage system 100 shown in FIG. 3 includes back-end ports 102, one or more storage controllers 200, a cache (cache memory) 210, a common memory 220, one or more internal storages 230, and connecting units 240.

The storage controller 200 includes a processor 250, a memory 260, and a buffer 270. The processor 250 reads a program stored in the memory 260, and runs the read program to execute various processes. For example, the storage controller 200 executes a process according to a read/write request issued from the server 110. The memory 260 stores a program that defines operations of the processor 250 and various pieces of information used by the processor 250. The buffer 270 stores redundant data, which will be described later, and information necessary for generating the redundant data. The buffer 270 serves also as a storage area in which data cached in the cache memory 210 is temporarily held before being permanently stored in a storage unit (the storage unit 160 in the storage box 120, or the internal storage 230).

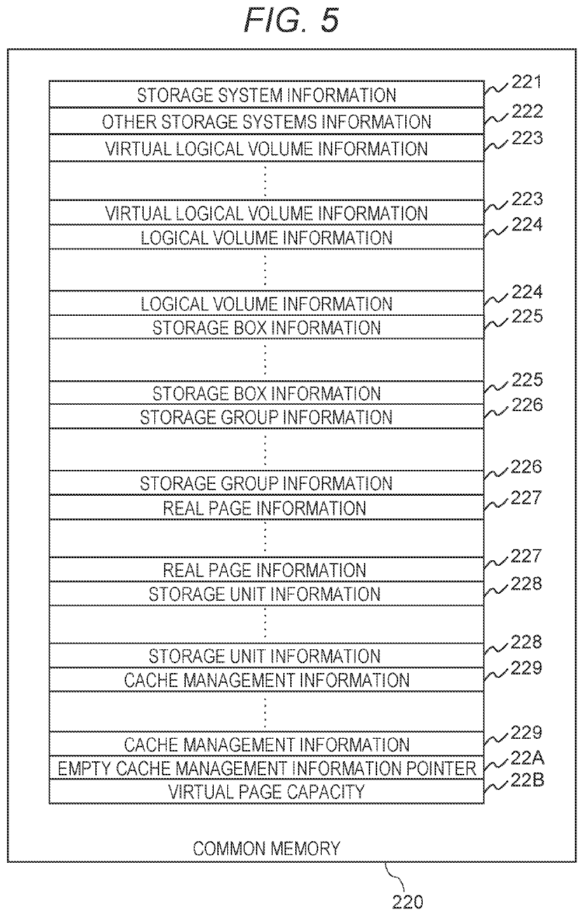

The cache memory 210 and the common memory 220 are composed of, for example, a non-volatile memory, such as a dynamic random access memory (DRAM). It is preferable that the cache memory 210 and the common memory 220 be made non-volatile by supplying them with power from a battery or the like. The cache memory 210 and the common memory 220 may be duplicated to ensure their high reliability. The cache memory 210 caches a piece of data frequently accessed by the storage controller 200, the piece of data being among data stored in the internal storage 230 and the storage unit 160 in the storage box 120. Data stored in the common memory 220 will be described later (see FIG. 5).

The internal storage 230 is a storage unit having a storage medium similar to that of the storage unit 160 in the storage box 120. The real storage system 100 controls data reading/writing from/to the internal storage 230, as the storage unit 160 does. The internal storage 230 may be not provided. According to the present embodiment, unless otherwise specified, the real storage system 100 writes data to the storage unit 160. The real storage system 100, however, may write data to the internal storage 230.

The connecting units 240 interconnect internal units making up the real storage system 100, i.e., the storage controller 200 to the internal storage 230. The storage controller 200 is connected to one or more storage boxes 120 via the connecting unit 240. This allows the storage controller 200 to read and write data from and to the storage unit 160 in one or more storage boxes 120. In the present embodiment, the storage box 120 is connected to one or more storage controllers 200 in the real storage system 100.

FIG. 4 depicts an example of a configuration of the cache memory 210. The cache memory 210 shown in FIG. 4 is divided into fixed-length slots 211. The slot 211 is a unit of read/write data allocation.

In the present embodiment, the storage controller 200, when receiving a write request, carries out a write process in the following manner: the storage controller 200 writes write data, which is to be written in according to the write request, to the cache memory 210 and then transfers the write data from the cache memory 210 to the storage unit 160. Upon writing the write data to the cache memory 210, the storage controller 200 returns response information indicating completion of the write request to the server 110, and then transfers the write data from the cache memory 210 to the storage unit 160 at a given point of time. The storage controller 200 may return the response information when storing the write data in the storage unit 160.

The information system of the present embodiment has a redundancy array independent device (RAID) function by which even if a failure occurs at one of the storage units 160, data stored in the storage unit 160 having the failure can be recovered, as a RAID 1 or a RAID 5 does. In the present embodiment, a RAID group is composed of a set of storage units 160 in one storage box or a set of internal storages 230 in one real storage system.

FIG. 5 depicts an example of information stored in the common memory 220. In the example of FIG. 5, the common memory 220 includes storage system information 221, other storage systems information 222, virtual logical volume information 223, logical volume information 224, storage box information 225, storage group information 226, real page information 227, storage unit information 228, cache management information 229, an empty cache management information pointer 22A, and a virtual page capacity 22B.

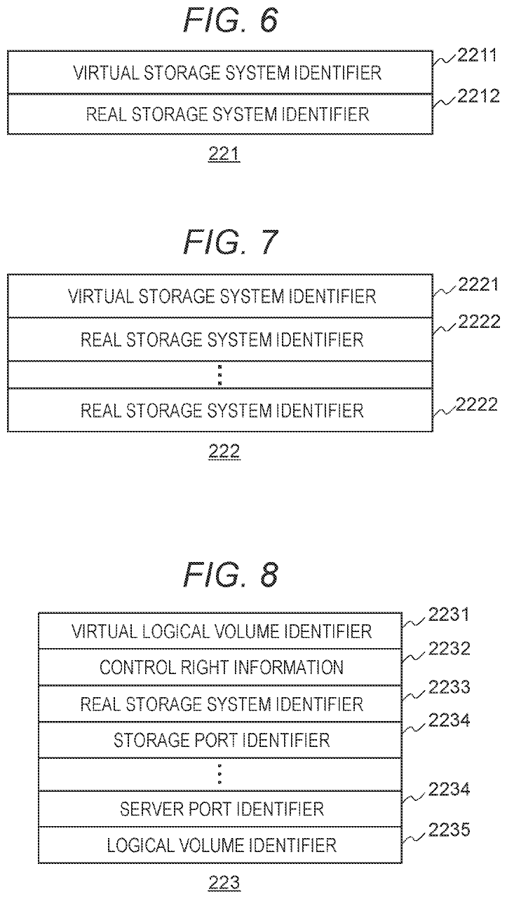

FIG. 6 depicts an example of the storage system information 221. The storage system information 221 is information on a real storage system 100 (relevant real storage system 100) having the common memory 220 storing the storage system information 221 therein. The storage system information 221 includes a virtual storage system identifier 2211 and a real storage system identifier 2212.

The virtual storage system identifier 2211 is an identifier for identifying the virtual storage system 180 including the relevant real storage system 100. The real storage system identifier 2212 is an identifier for identifying the relevant real storage system 100.

FIG. 7 depicts an example of the other storage systems information 222. The other storage systems information 222 is information on different (other) real storage systems 100 different from the relevant real storage system 100. The other storage systems information 222 includes a virtual storage system identifier 2221 and an other real storage systems identifier (real storage system identifier) 2222.

The virtual storage system identifier 2221 is an identifier for identifying the virtual storage system 180 including the relevant real storage system 100. The other real storage systems identifier 2222 is an identifier for identifying a different real storage system 100 included in the virtual storage system 180 including the relevant real storage system 100.

FIG. 8 depicts an example of the virtual logical volume information 223. The virtual logical volume information 223 is information on a virtual logical volume and is set for each virtual logical volume. The virtual logical volume information 223 includes a virtual logical volume identifier 2231, control right information 2232, a control right real storage system identifier (real storage system identifier) 2233, a control right storage path identifier (storage port identifier) 2234, and a control right logical volume identifier (logical volume identifier) 2235.

The virtual logical volume identifier 2231 is an identifier for identifying the virtual logical volume. The control right information 2232 indicates whether the relevant real storage system 100 has a control right over the virtual logical volume. The control right is an authority to input and output data to and from the virtual logical volume, and is allocated to one of the real storage systems 100.

The control right real storage system identifier 2233 and the control right storage path identifier 2234 are information that when the relevant real storage system 100 does not have the control right over the virtual logical volume, identifies a real storage system having the control right. The control right real storage system identifier 2233 is an identifier for the real storage system having the control right. The control right storage path identifier 2234 is an identifier for one or more storage paths connected to the virtual logical volume. The control right logical volume identifier 2235 is an identifier for a logical volume in the real storage system 100 having the control right.

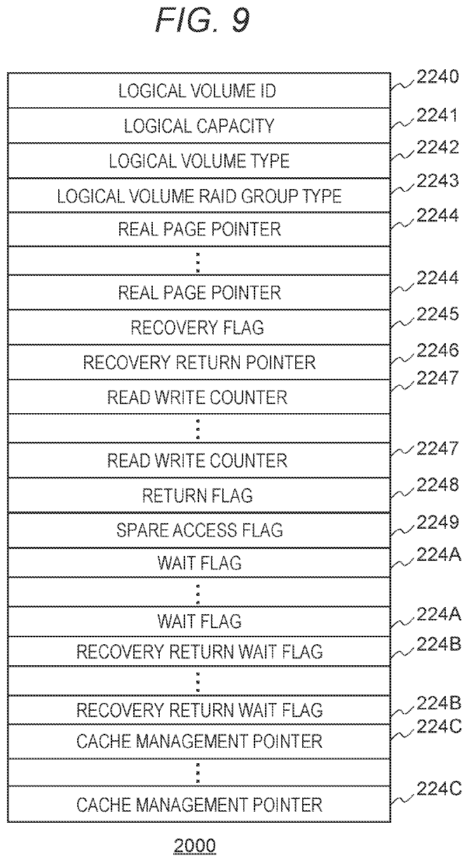

FIG. 9 depicts an example of the logical volume information 224. The logical volume information 224 is present for each of logical volumes included in the relevant real storage system. The logical volume information 224 includes a logical volume identifier (logical volume ID) 2240, a logical capacity 2241, a logical volume type 2242, a logical volume RAID group type 2243, a real page pointer 2244, a recovery flag 2245, a recovery/return pointer 2246, a read/write counter 2247, a return flag 2248, a spare access flag 2249, a wait flag 224A, a recovery/return wait flag 224B, and a cache management information pointer (cache management pointer) 224C.

The logical volume identifier 2240 is an identifier for identifying the logical volume. The logical capacity 2241 indicates the capacity of the logical volume. The logical volume type 2242 indicates the type of the logical volume. The logical volume type 2242 indicates, for example, whether the logical volume is stored in the internal storage 230 or in the storage unit 160. The logical volume RAID group type 2243 indicates the RAID type of the logical volume, such as RAID 0 or RAID 5. The logical volume RAID group type 2243 further indicates a specific numerical value denoted by N when, for example, one storage unit for storing redundant data is needed for N storage units for storing data (user data), as in the case of the RAID 5. It should be noted that the logical volume RAID group type 2243 indicates not an any given RAID type but a RAID type corresponding to at least one storage group 280.

The real page pointer 2244 indicates the address of a real page to which a virtual page, which is a partial space of the logical volume, is allocated. In the present embodiment, as described above, the real storage system 100 has the capacity virtualization function. The capacity virtualization function is a function of allocating a real page including an area for storing write data corresponding to a write request, to a virtual page, which is a partial space of a logical volume. The logical volume information 224, therefore, includes real page pointers 2244 of which the number is given by dividing the capacity of the logical volume by the size of virtual pages.

The recovery flag 2245 indicates whether a recovery process of recovering data is being executed on one of the storage units 160. According to the present embodiment, when a failure occurs at a storage unit 160, the real storage system 100 executes the recovery process of recovering (restoring) data stored in the storage unit 160 having the failure occurred. The recovery process on a real page to which a virtual page of the logical volume is allocated (i.e., real page carrying data to be recovered) is executed by the storage controller 200 in the real storage system 100 having the control right over the real page. The recovery process on an empty page, which is a real page to which a virtual page of the logical volume is allocated, is executed by the storage controller 200 in the real storage system 100 having the allocation authority to allocate the virtual page to the empty page. The allocation authority is allocated to one of the real storage systems 100. In the present embodiment, one or more storage units 160 are specified in advance as spare units, and the storage controller 200 having executed a recovery process writes recovered data, which is data recovered by the recovery process, to one of the spare units. The storage controller 200 having executed the recovery process may write separate parts of the recovery data respectively to a plurality of spare units. In the present embodiment, the recovery process is executed in units of logical volumes. The recovery process, however, may be executed in units of storage groups including a storage unit 160 having a failure or may be executed in other units. In the present embodiment, the recovery process on an empty area is executed in units of storage groups.

The recovering/return pointer 2246 is information indicating the status of progress of a recovery process and a returning process on a logical volume, serving as a pointer that points a virtual page on which the recovery process and the returning process are in progress. The returning process is a process by which, after a storage unit 160 having a failure is replaced with a new storage unit 160, recovered data stored in a spare unit is transferred from the spare unit to the new storage unit 160. In the present embodiment, the returning process is carried out by the storage controller 200 having carried out the recovery process. It should be noted that the returning process may be not executed. In other words, the spare unit may be used as a normal storage unit 160, without having the recovered data transferred.

The read/write counter 2247 is set for each virtual page, and indicates the number of read/write requests to the virtual page. The return flag 2248 indicates whether the returning process is being executed on one of the storage units 160. The spare access flag 2249 indicates whether access to a spare unit is possible.

The wait flag 224A is set for each virtual page, and indicates whether a read/write request to the virtual page that is in a wait state is present. The wait flag 224A is turned on when a read/write request to the virtual page is issued during execution of the recovery process or the returning process on the virtual page.

The recovery/return wait flag 224B is set for each virtual page, and indicates whether the recovery process or returning process on the virtual page that is in a wait state is present. The recovery/return wait flag 224B is turned on when time to execute the recovery process or returning process arrives during execution of a read/write process on the virtual page.

The cache management information pointer 224C is set for each of slot areas of the logical volume, the slot areas being created by dividing the logical volume by the capacities corresponding to the slots 211 of the cache memory 210, and indicates whether the slot 211 is allocated to the slot area (whether data corresponding to the slot area is stored in the cache memory 210). When the slot 211 is allocated, the cache management information pointer 224C points cache management information 229 (see FIG. 15) corresponding to the slot 211. When the slot 211 is not allocated, on the other hand, the cache management information pointer 224C points a null state.

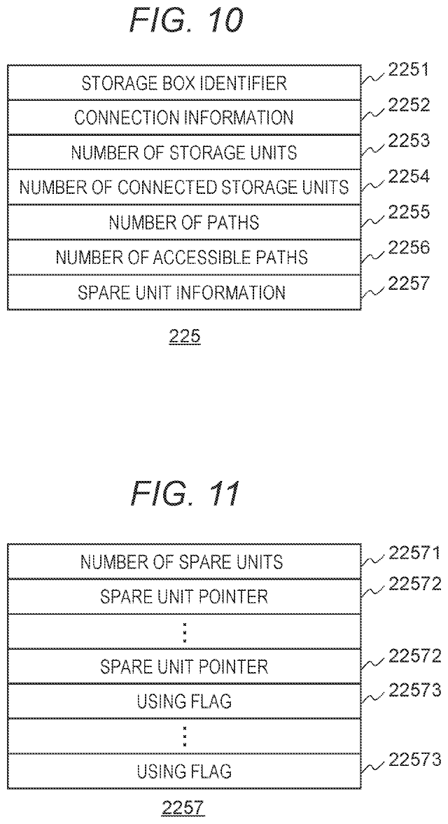

FIG. 10 depicts an example of the storage box information 225. The storage box information 225 is information on the storage boxes 120, and is set for each storage box 120. The storage box information 225 includes a storage box identifier 2251, connection information 2252, number of storage units 2253, number of connected storage units 2254, number of paths 2255, a path identifier (number of accessible paths) 2256, and spare unit information 2257.

The storage box identifier 2251 is an identifier for identifying a storage box 120. The connection information 2252 indicates whether the storage box 120 is connected to the real storage system 100. The number of storage units 2253 indicates the number of storage units 160 that can be connected to the storage box 120. The number of connected storage units 2254 indicates the number of storage units 160 actually connected to the storage box 120. The number of paths 2255 indicates the number of paths connected to the storage box 120. The path identifier 2256 is set for each of paths connected to the storage box 120 to identify the connected path. The spare unit information 2257 is information on a storage unit 160 used as a spare unit included in the storage box 120.

FIG. 11 depicts an example of the spare unit information 2257. The spare unit information 2257 includes number of spare units 22571, a spare unit pointer 22572, and a using flag 22573.

The number of spare units 22571 indicates the number of spare units included in the storage box 120. The spare unit pointer 22572 is set for each of spare units included in the storage box 120, and indicates the storage unit 160 serving as the spare unit. The using flag 22573 is set for each of spare units included in the storage box 120, and indicates whether the spare unit is in use.

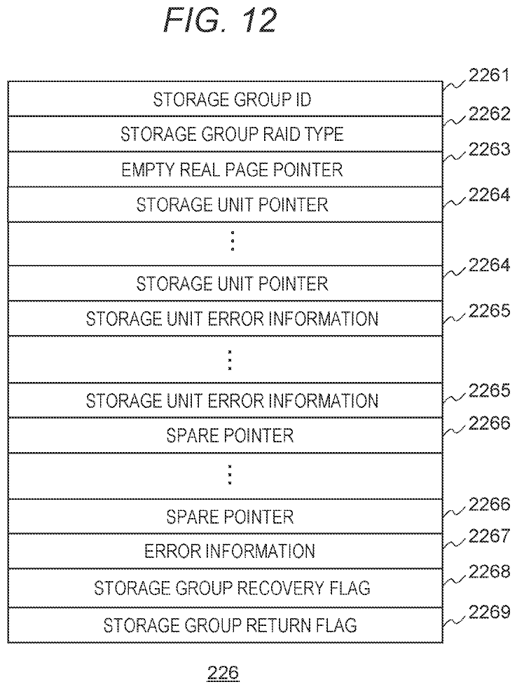

FIG. 12 depicts an example of the storage group information 226. The storage group information 226 is information on storage groups, and is set for each of the storage groups. The storage group information 226 includes a storage group identifier (storage group ID) 2261, a storage group RAID type 2262, an empty real page information pointer (empty real page pointer) 2263, a storage unit pointer 2264, storage unit failure information (storage unit error information) 2265, a spare pointer 2266, failure information (error information) 2267, a storage group recovery flag 2268, and a storage group return flag 2269.

The storage group identifier 2261 is an identifier for identifying a storage group. In the present embodiment, a storage group is made up of storage units 160 included in one storage box 120, and the storage group identifier 2261 identifies the storage box 120 including the storage group. The storage group RAID type 2262 indicates the RAID type of the storage group.

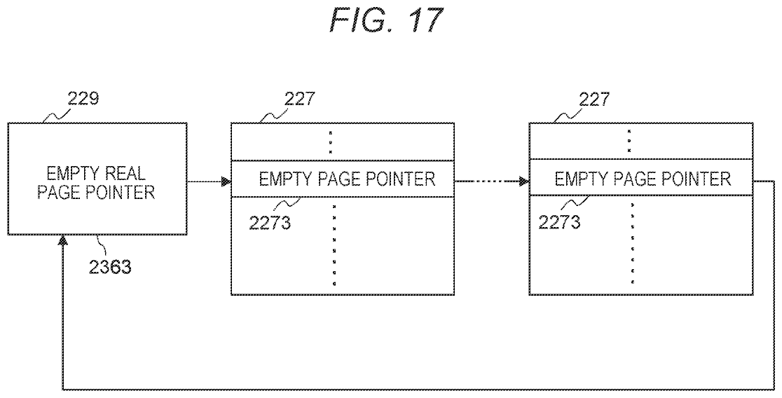

The empty real page information pointer 2263 indicates real page information 227 on an empty real page to which no virtual page is allocated (see FIG. 17). The storage unit pointer 2264 is set for each of storage units 160 included in the storage group, and indicates storage unit information 228 about the storage unit 160. The storage unit failure information 2265 is set for each of storage units 160 included in the storage group, and indicates whether the storage unit 160 is in a normal state (a state of having no failure). The spare pointer 2266 is set for each of storage units 160 included in the storage group, and when a spare unit is used in place of the storage unit 160 at which a failure has occurred, points storage unit information 228 on the spare unit. The failure information 2267 indicates whether a failure has occurred at least at one of the storage units 160 included in the storage group.

The storage group recovery flag 2268 indicates whether the recovery process is being executed on at least one of the storage units 160 included in the storage group. The storage group return flag 2269 indicates whether the returning process is being executed on at least one of the storage units 160 included in the storage group.

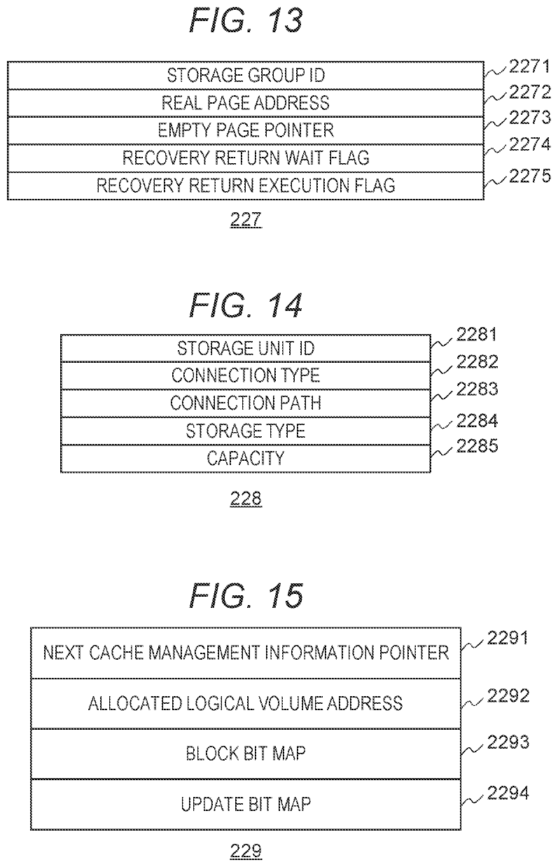

FIG. 13 depicts an example of the real page information 227. The real page information 227 is set for each real page to manage the real page. The real page information 227 includes a storage group identifier (storage group ID) 2271, a real page address 2272, an empty page pointer 2273, a recovery/return wait flag 2274, and a recovery/return execution flag 2275.

The storage group identifier 2271 identifies a storage group to which a real page is allocated. The real page address 2272 indicates the address of the real page in the storage group to which the real page is allocated. The empty page pointer 2273 is information that represents a valid value when no virtual page is allocated to the real page, and points real page information 227 of the next real page to which no virtual page is allocated, the next real page being in the storage group. The recovery/return wait flag 2274 indicates whether the recovery process or returning process on the real page is in a wait state. The recovery/return execution flag 2275 indicates whether the recovery process or returning process on the real page is in progress.

FIG. 14 depicts an example of the storage unit information 228. The storage unit information 228 is information on storage units (the storage units 160 and the internal storages 230), and is set for each storage unit. The storage unit information 228 includes a storage unit identifier (storage unit ID) 2281, a connection type 2282, a connection path 2283, a storage type 2284, and a capacity 2285.

The storage unit identifier 2281 is an identifier for identifying a storage unit. The connection type 2282 indicates whether the storage unit is the storage unit 160 or the internal storage 230. When the storage unit is the storage unit 160, the connection path 2283 indicates an identifier for a path connected to the storage unit. The storage type 2284 indicates the type of a storage medium incorporated in the storage unit. The capacity 2285 indicates the capacity of the storage unit. It should be noted that in the present embodiment, the storage types (storage type 2284) and capacities (capacity 2285) of all storage units included in the storage group are equal to each other.

FIG. 15 is an example of the cache management information 229. The cache management information 229 is set for each slot 211. The cache management information 229 includes a next cache management information pointer 2291, an allocated logical volume address 2292, a block bitmap 2293, and an update bitmap 2294.

The next cache management information pointer 2291 is information that is valid in cache management information 229 corresponding to a slot holding no data, serving as a pointer that points cache management information 229 corresponding to the next slot holding no data. The allocated logical volume address 2292 indicates which data from which area starting from which address in which logical volume is stored in the slot 211 corresponding to the cache management information 229. The block bitmap 2293 indicates a block (minimum unit of reading and writing) stored in the cache memory 210, the block being in an allocated area. Bits of the block bitmap 2293 are set ON when a block corresponding to the bits is stored in the cache memory 210. The update bitmap 2294 indicates a block of data for which a write request from the server 110 has been received and which is sent from the server 110 and stored in the cache memory 210, that is, indicates a block of data that is not written to the storage unit 160 yet. Bits of the update bitmap 2294 are set ON when a block of data corresponding to the bits is a block of data not written to the storage unit 160 yet.

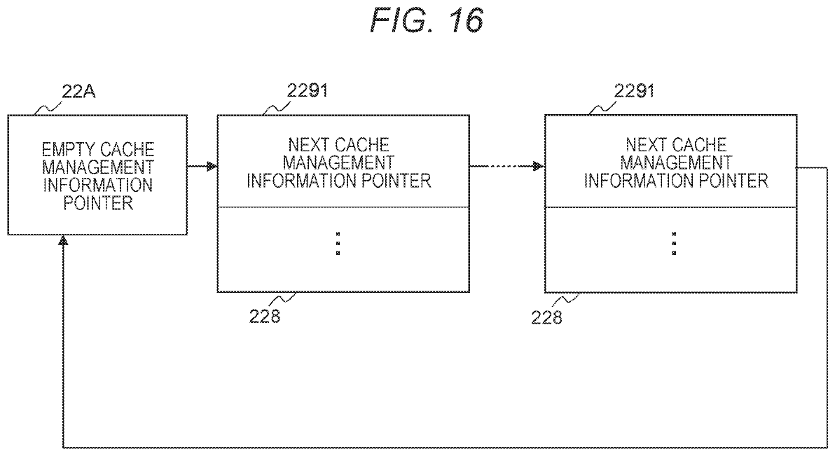

FIG. 16 is a diagram for explaining the empty cache management information pointer 22A. As indicated in FIG. 16, the empty cache management information pointer 22A points cache management information 229 corresponding to the head slot holding no data among the slots 211 of the cache memory 210. Next cache management information pointer 2291 included in the cache management information 229 corresponding to the head slot points cache management information 229 corresponding to the next slot holding no data. In the same manner, pieces of cache management information 229 corresponding to slots holding no data are pointed in sequence up to cache management information 229 corresponding to the last slot holding no data. In the example of FIG. 16, next cache management information pointer 2291 included in the cache management information 229 corresponding to the last slot points the empty cache management information pointer 22A. The next cache management information pointer 2291, however, may point a null value.

The virtual page capacity 22B shown in FIG. 5 is the capacity of a virtual page. The virtual page capacity 22B is not necessarily equal to the capacity of a real page because the capacity of the real page varies depending on RAID types. For example, when write data is duplicated as in the case of RAID 1, the capacity of the real page is twice as large as the virtual page capacity 22B. When one storage unit that stores redundant data is needed for N storage units, as in the case of RAID 5, the capacity of the real page is equal to “virtual page capacity 22B×(N+1)/N.” It is assumed in the present embodiment that the virtual page capacities 22B of all virtual pages in the real storage system 100 are equal. A virtual page with a different virtual page capacity 22B, however, may be present among those virtual pages. In the present embodiment, the storage group is configured as the RAID 5. The storage group, however, may be configured as a different type of RAID.

FIG. 17 is a diagram for explaining the empty real page information pointer 2263 shown in FIG. 12. FIG. 17 shows a set of empty real pages managed by the empty real page information pointer 2263. An empty real page is a real page to which no virtual page is allocated. Hereinafter, real page information 227 corresponding to an empty real page may be referred to as empty real page information 227.

The empty real page information 227 is used in the recovery process on an empty real page. In the present embodiment, as described above, the storage controller 200 in the real storage system 100 carries out the recovery process on an empty page, the real storage system 100 having an allocation authority over the empty page. Thus, a set of empty pages, over which each real storage system 100 has the allocation authority, are managed by the empty real page information pointer 2263. A different set of empty real pages are, therefore, managed for each real storage system 100.

The empty real page information pointer 2263 points the address of empty real page information 227 corresponding to the head empty real page. The empty page pointer 2273 included in the empty real page information 227 corresponding to the head empty real page points empty real page information 227 corresponding to the next empty real page. In the same manner, pieces of empty real page information 227 corresponding to empty real pages are pointed in sequence. In the example of FIG. 17, the empty page pointer 2273 included in empty real page information 227 corresponding to the last empty real page points the empty real page information pointer 2263. This empty page pointer 2273, however, may point a null value.

When receiving a write request to a virtual page to which no real page is allocated, the storage controller 200 retrieves an empty real page, using the empty real page information pointer 2263 corresponding to one of storage groups of RAID types indicated by the logical volume RAID group type 2243 (e.g., a storage group having the greatest number of empty real pages), and allocates the retrieved empty real page to the virtual page.

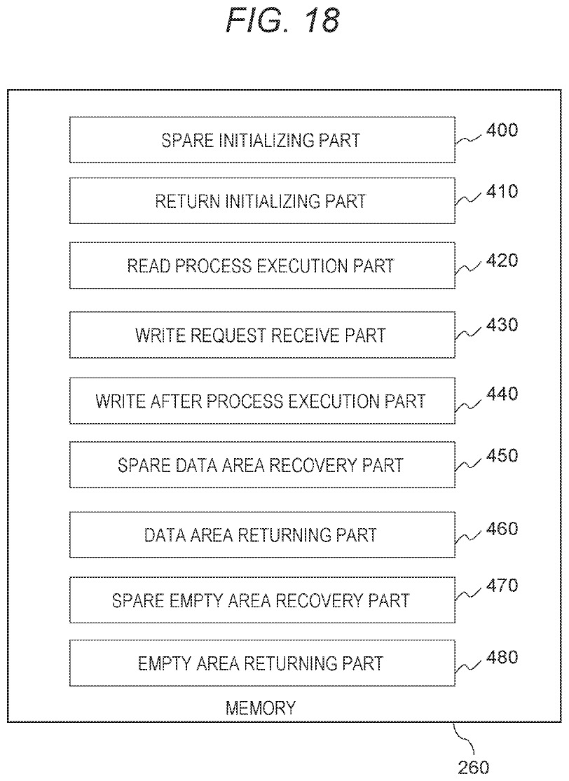

Processes the storage controller 200 executes using the above-described management information will then be described. It should be noted that the processor 250 in the storage controller 200 reads programs recorded in the memory 260 and executes the read programs to carry out the following processes. FIG. 18 depicts a functional configuration created by executing a program recorded in the memory 260.

As shown in FIG. 18, execution of the program provides a spare initializing part 400, a return initializing part 410, a read process execution part 420, a write request receive part 430, a write-after process execution part 440, a spare data area recovery part 450, a data area returning part 460, a spare empty area recovery part 470, and an empty area returning part 480.

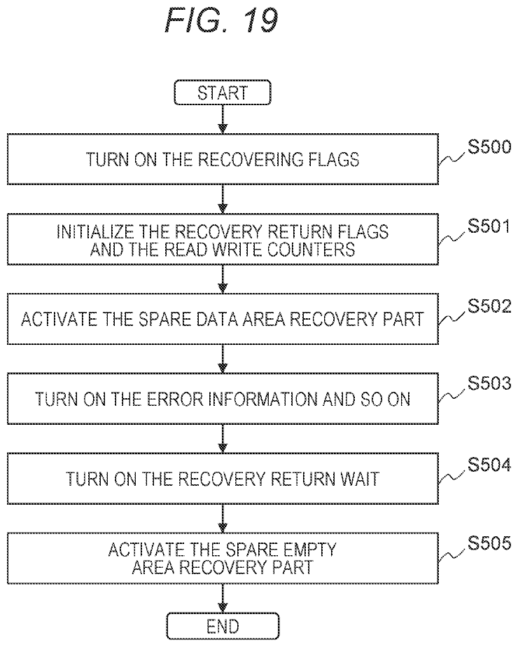

FIG. 19 is a flowchart for explaining an example of a spare initializing process carried out by the spare initializing part 400. The spare initializing process is executed when a failure occurs at one of the storage units 160. In the present embodiment, the spare initializing process is executed by the storage controller 200 capable of accessing a storage group including the storage unit 160 having the failure occurred. The spare initializing process is included in the recovery process.

At step S500, the spare initializing part 400 turns on the recovery flags 2245 of logical volume information 224 of all logical volumes over which the storage controller 200 has the control right, the logical volumes being the target storage group (the storage group including the storage unit 160 having the failure).

At step S501, the spare initializing part 400 initializes the recovery/return pointers 2246 of logical volume information 224 of all logical volumes over which the storage controller 200 has the control right. In addition, the spare initializing part 400 initializes all read/write counters 2247 in the logical volume information 224.

At step S502, the spare initializing part 400 activates the spare data area recovery part 450 corresponding to all logical volumes over which the storage controller 200 has the control right.

At step S503, the spare initializing part 400 turns on the failure information 2267 and the storage group recovery flag 2268 in the storage group information 226 corresponding to the storage group including the storage unit 160 having the failure, and turns on also the storage unit failure information 2265 of the storage unit 160 having the failure. The spare initializing part 400 then refers to the spare unit information 2257 in the storage box information 225 corresponding to the storage box 120 including the storage unit 160 having the failure, retrieves a spare unit (storage unit 160) for which the using flag 22573 is set off, and sets a spare pointer 2266 pointing the retrieved storage unit 160.

At step S504, in the storage group including the storage unit 160 having the failure, the spare initializing part 400 turns on the recovery/return wait flags 2274 of real page information 227 corresponding to all empty real pages over which the storage controller 200 has the allocation authority. As a result, real pages corresponding to real page information 227 that can be retrieved using the empty real page information pointer 2263 of the storage group information 226 of the storage group including the storage unit 160 having the failure (a set of real page information 227 shown in FIG. 17) become the subject of the recovery process.

At step S505, the spare initializing part 400 activates the spare empty area recovery part 470 corresponding to the storage group including the storage unit 160 having the failure, and ends the whole process flow.

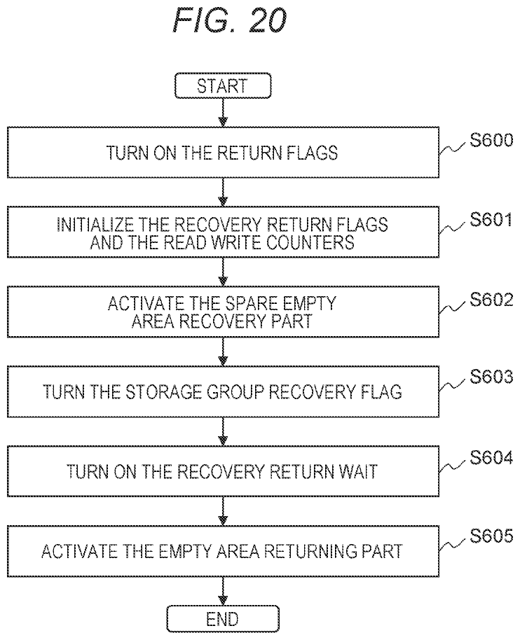

FIG. 20 is a flowchart for explaining an example of a return initializing process carried out by the return initializing part 410. The return initializing process is executed after the storage unit 160 having the failure is replaced with a new storage unit 160. In the present embodiment, the return initializing process is executed by the storage controller 200 capable of accessing a storage group including the new storage unit 160. The return initializing process is included in the return process.

At step S600, the return initializing part 410 turns on the return flags 2248 of logical volume information 224 of all logical volumes over which the storage controller 200 has the control right.

At step S601, the return initializing part 410 initializes the recovery/return pointers 2246 of logical volume information 224 of all logical volumes over which the storage controller 200 has the control right. The return initializing part 410 initializes also all read/write counters 2247 in the logical volume information 224.

At step S602, the return initializing part 410 activates the data area returning part 460 corresponding to all logical volumes over which the storage controller 200 has the control right.

At step S603, the return initializing part 410 turns on the storage group return flag 2269 in the storage group information 226 corresponding to the storage group including the storage unit 160 having the failure.

At step S604, in the storage group including the storage unit 160 having the failure, the return initializing part 410 turns on the recovery/return wait flag 2274 of the real page information 227 corresponding to all empty real pages over which the storage controller 200 has the allocation authority.

At step S605, the return initializing part 410 activates the empty area returning part 480 corresponding to the storage group including the storage unit 160 having the failure.

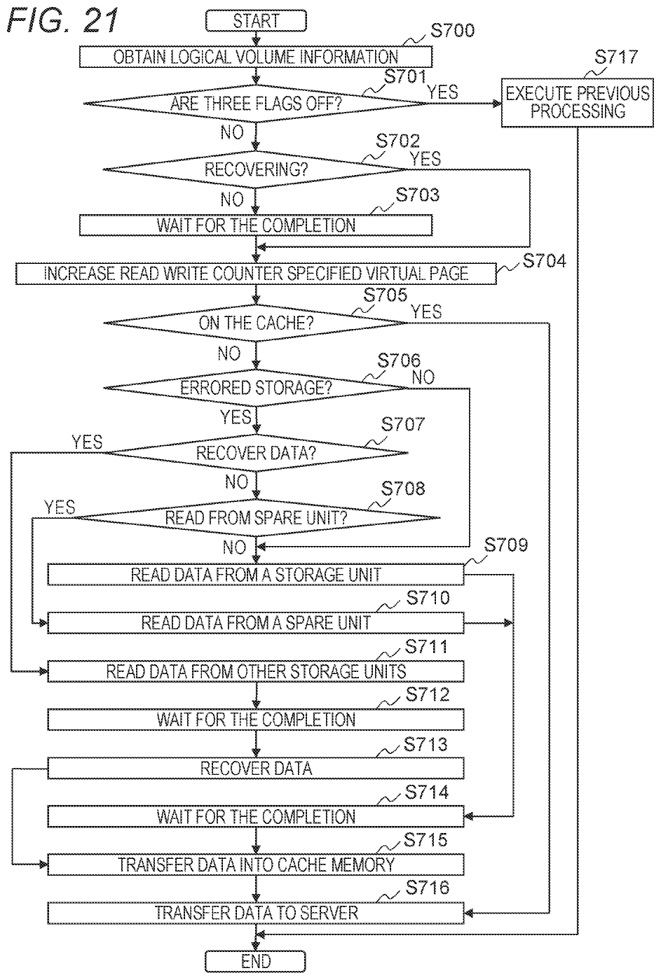

FIG. 21 is a flowchart for explaining an example of a read process carried out by the read process execution part 420. The read process is executed when the storage controller 200 receives a read request from the server 110.

At step S700, the read process execution part 420 converts a virtual logical volume of an address specified by the read request into a logical volume, using the virtual logical volume information 223, and acquires the logical volume information 224 of the logical volume.

At step S701, the read process execution part 420 determines whether the recovery flag 2245, the return flag 2248, and the spare access flag 2249 of the logical volume information 224 are all off. The read process execution part 420 executes a process of step S702 when any one of these flags is on, and executes a process of step S717 when the flags are all off. At step S717, the read process execution part 420 carries out a normal read process for a case of no failure occurring at the storage unit 160, and ends the whole process flow.

At step S702, the read process execution part 420 specifies a virtual page corresponding to the address specified by the read request. The read process execution part 420 then confirms the recovery/return pointer 2246 of the logical volume information 224, and checks if a recovery process or a returning process on the virtual page is being executed. The read process execution part 420 executes a process of step S703 when the recovery process or the returning process is being executed, and executes a process of step S704 when the recovery process or the returning process is not being executed.

At step S703, the read process execution part 420 stands by until the recovery process or the returning process ends.

At step S704, the read process execution part 420 increases the value of the read/write counter 2247 for the virtual page corresponding to the address designated by the read request by 1, the read/write counter 2247 being included in the logical volume information 224.

At step S705, the read process execution part 420 checks whether data specified by the read request is stored in the cache memory 210, based on the address specified by the read request, the cache management pointer 224C of the logical volume information 224, and the block bitmap 2293 of the cache management information 229. The read process execution part 420 executes a process of step S716 when the data is stored in the cache memory 210, and executes a process of step S706 when the data is not stored in the cache memory 210.

At step S706, the read process execution part 420 checks whether a failure has occurred at a storage unit 160 having a real page to which the virtual page corresponding to the address specified by the read request is allocated. The read process execution part 420 executes a process of step S707 when the failure has occurred, and executes a process of step S709 when the failure has not occurred.

At step S707, the read process execution part 420 determines whether the recovery process related to the address specified by the read request is completed, based on the recovery/return pointer 2246, and determines whether it is necessary to recover data stored in the storage unit 160 having the failure from data stored in a different storage unit 160 belonging to the same storage group. The recovery process related to the address is a process of recovering the virtual page corresponding to the address. When the recovery process is completed, the read process execution part 420 determines that it is unnecessary to recover the data and executes a process of step S708. When the recovery process is not completed, the read process execution part 420 determines that it is necessary to recover the data and executes a process of step S711.

At step S708, the read process execution part 420 determines whether or not to read data from a spare unit. Specifically, when the recovery flag 2245 is on and the recovery/return pointer 2246 indicates completion of the recovery process related to the address specified by the read request, or when the return flag 2248 is on and the recovery/return pointer 2246 indicates non-completion of a returning process related to the address specified by the read request, or when the spare access flag 2249 is on, the read process execution part 420 determines to read the data from the spare unit. The read process execution part 420 executes the process of step S709 when not reading the data from the spare unit, and executes a process of step S710 when reading the data from the spare unit.

At step S709, since the read process execution part 420 can read data from the storage unit 160 corresponding to the address specified by the read request, the read process execution part 420 issues a read request to the storage unit 160. Subsequently, step S714 is executed.

At step S710, to read data from the spare unit, the read process execution part read 420 issues a read request to the storage unit 160 serving as the spare unit. Subsequently, step S714 is executed.

At step S711, because the read process execution part 420 needs to read necessary data (redundant data or the like) from a different storage unit 160 in the storage group and recover the data, the read process execution part 420 issues a read request to the different storage unit 160 in the storage group.

At step S712, the read process execution part 420 stands by until the read request to the different storage unit 160 has been processed completely.

At step S713, based on data acquired as a response to the read request to the different storage unit 160, the read process execution part 420 recovers the data corresponding to the read request from the server. Subsequently, step S715 is executed.

At step S714, the read process execution part 420 stands by until the read request transmitted at step S709 or S710 has been processed completely.

At step S715, the read process execution part 420 transfers the read data or the recovered data to the cache memory 210 and stores the data therein, and updates the cache management information 229 (i.e., block bitmap 2293 or the like).

At step S716, the read process execution part 420 transfers the data stored in the cache memory 210, to the server 110. Further, the read process execution part 420 specifies a virtual page corresponding to the address specified by the read request, decreases the value of the read/write counter 2247 corresponding to the virtual page by 1, and ends the whole process flow.

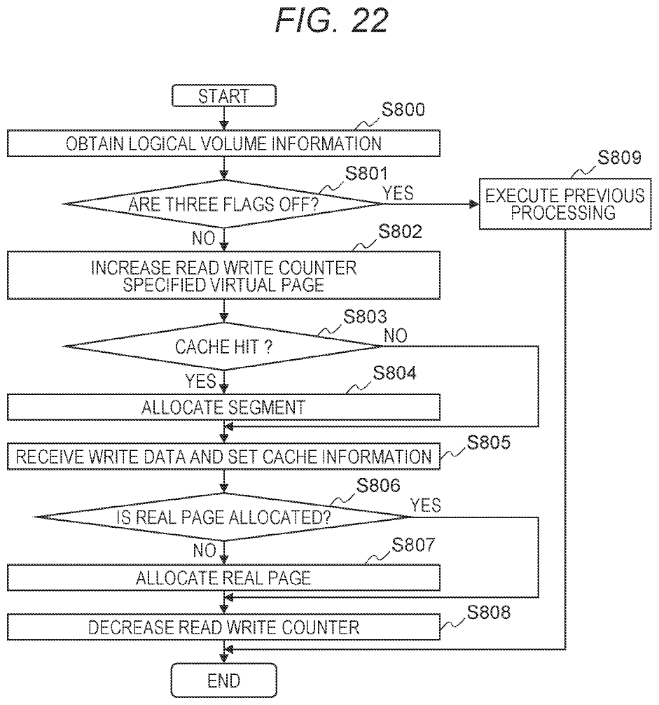

FIG. 22 is a flowchart for explaining an example of a write request receiving process carried out by the write request receive part 430. The write request receiving process is executed when the storage controller 200 receives a write request from the server 110.

At step S800, the write request receive part 430 converts a virtual logical volume corresponding to an address specified by the write request into a logical volume, using the virtual logical volume information 223, and acquires the logical volume information 224 of the logical volume.

At step S801, the write request receive part 430 determines whether the recovery flag 2245, the return flag 2248, and the spare access flag 2249 in the logical volume information 224 are all off. The read process execution part 420 executes a process of step S802 when any one of these flags is on, and executes a process of step S809 when the flags are all off. At step S809, the write request receive part 430 carries out a normal write request receiving process for a case of no failure has occurred at the storage unit 160, and ends the whole process flow.

At step S802, the write request receive part 430 specifies a virtual page corresponding to the address specified by the write request, and increase the value of the read/write counter 2247 corresponding to the virtual page by 1.

At step S803, the write request receive part 430 checks whether data specified by the write request is found in the cache memory 210, based on the address specified by the write request, the cache management pointer 224C of the logical volume information 224, and the block bitmap 2293 of the cache management information 229. The write request receive pat 430 executes a process of step S804 when the data is found, and executes a process of step S805 when the data is not found.

At step S804, the write request receive part 430 sets the cache management information 229 at the head indicated by the empty cache management information pointer 22A in the corresponding cache management information pointer 224C of the logical volume information 224, thereby allocating the slot 211 of the cache memory 210 to the logical volume. Further, the write request receive part 430 sets the identifier and the address of the logical volume in the allocated logical volume address 2292 of the cache management information 229.

At step S805, the write request receive part 430 acquires data specified by the write request from the server 110, and stores the data in the cache memory 210. The write request receive part 430 updates the block bitmap 2293 and the update bitmap 2294 of the cache management information 229.

At step S806, the write request reception unit 430 checks whether a real page is allocated to the virtual page, based on the real page pointer 2244 corresponding to the virtual page corresponding to the address specified by the write request. The write request receive part 430 executes a processing of step S807 when the real page is not allocated, and executes a process of step S808 when the real page is allocated.

At step S807, the write request receive part 430 secures the real page information 227 of a real page which is in an empty state and for which the recovery/return wait flag 2274 is off, from the empty real page information pointer 2263 of the corresponding storage group information 226, and sets the address of the real page to the real page pointer 2244 for the corresponding virtual page.

At step S808, the write request receive part 430 decreases the value of the read/write counter by 1, and ends the whole process flow.

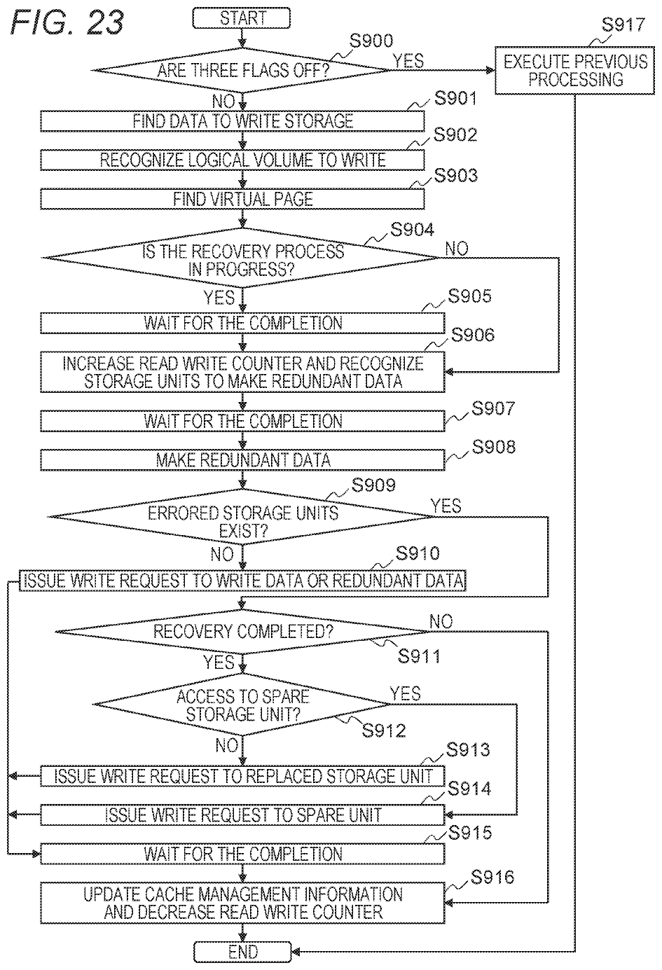

FIG. 23 is a flowchart for explaining an example of a write-after process that the write-after process execution part 440 carries out. The write-after process is executed at given timing.

At step S900, the write-after process execution part 440 determines whether the recovery flag 2245, the return flag 2248, and the spare access flag 2249 of the logical volume information 224 of a logical volume to be subjected to the write-after process are all off. The read process execution part 420 executes a process of step S901 when any one of these flags is on, and executes a process of step S917 when the flags are all off. At step S917, the write-after process execution part 440 carries out a normal write-after process for a case of no failure has occurred at the storage unit 160, and ends the whole process flow.

At step S901, the write-after process execution part 440 searches the cache management information 229 in which the update bitmap 2294 is on, and finds data not written to the storage unit 160.

At step S902, the write-after process execution part 440 checks the allocated logical volume address 2292 of the searched cache management information 229, and recognizes a logical volume corresponding to a slot storing the data not written to the storage unit 160.

At step S903, the write-after process execution part 440 specifies the virtual page corresponding to the recognized logical volume, based on the update bitmap 2294 of the searched cache management information 229.

At step S904, the write-after process execution part 440 refers to the recovery/return pointer 2246, and checks whether a recovery process or a returning process on the virtual page is being executed. The write-after process execution part 440 executes step S905 when the recovery process or the returning process is being executed, and executes step S906 when the recovery process or the returning process is not being executed.

At step S905, the write-after process execution part 440 stands by until the recovery process or the returning process ends.

At step S906, the write-after process execution part 440 increases the value of the read/write counter 2247 corresponding to the virtual page by 1. The write-after process execution part 440 then recognizes the storage group corresponding to the virtual page, based on the storage group identifier 2271 of the real page information 227 of the real page corresponding to the virtual page. To read data necessary for generating redundant data corresponding to write data, the write-after process execution part 440 issues a read request to the storage unit 160 storing the necessary data, based on the logical volume RAID group type 2243, the recovery flag 2245, the recovery/return pointer 2246, the return flag 2248, the spare access flag 2249, and the like of the logical volume information 224.

At step S907, the write-after process execution part 440 stands by until the read request has been processed completely (until data reading is completed).

At step S908, the write-after process execution part 440 generates redundant data, based on the read data.

At step S909, referring to the storage group information 226 of the storage group, the write-after process execution part 440 checks whether a failure has occurred at the storage units 160 to which the write data and the redundant data are written, respectively. The write-after process execution part 440 executes a process of step S910 when the failure has not occurred, and executes a process of step S911 when the failure has occurred.

At step S910, the write-after process execution part 440 issues a write request to the storage unit 160. Specifically, the write-after process execution part 440 issues a write request for writing the write data, to the storage unit 160 to which the write data is to be written, and issues a write request for writing the redundant data, to the storage unit 160 to which the redundant data is to be written. Subsequently, the write-after process execution part 440 executes step S915.

At step S911, the write-after process execution part 440 checks whether a recovery process on an address to which the data is written is completed. Specifically, the write-after process execution part 440 determines whether the recovery process is completed, based on the recovering flag 2245 and the recovery/return pointer 2246. When the recovery process is completed, the write-after process execution part 440 executes step S912. When the recovery process is not completed, the write-after process execution part 440 executes step S916 because it does not carry out data writing in this case.

At step S912, the write-after process execution part 440 checks whether the returning process on the address to which the data is written is completed. Specifically, the write-after process execution part 440 determines whether the recovery process is completed, based on the return flag 2248 and the recovery/return pointer 2246. When the returning process is completed, the write-after process execution part 440 executes step S913. When the returning process is not completed, the write-after process execution part 440 executes a process of step S914 because in this case, if the spare access flag is on, the write-after process execution part 440 writes the write data or the redundant data to a spare unit.

At step S913, the write-after process execution part 440 writes the write data or the redundant data to a new storage unit 160, i.e., replacing storage unit 160 specified by the returning process. At this step, therefore, the write-after process execution part 440 issues a write request to the storage unit 160. Subsequently, a process of step S915 is executed.

At step S914, the write-after process execution part 440 writes the write data or the redundant data to the spare unit. At this step, therefore, the write-after process execution part 440 issues a write request to the spare unit. Subsequently, a process of step S915 is executed.

At step S915, the write-after process execution part 440 stands by until data writing-in has been completed.

At step S916, the write-after process execution part 440 resets the update bitmap 2294 of the searched cache management information 229. The write-after process execution part 440 then calculates a corresponding virtual page, decreases the value of the read/write counter 2247 corresponding to the virtual page by 1, and ends the whole process flow.

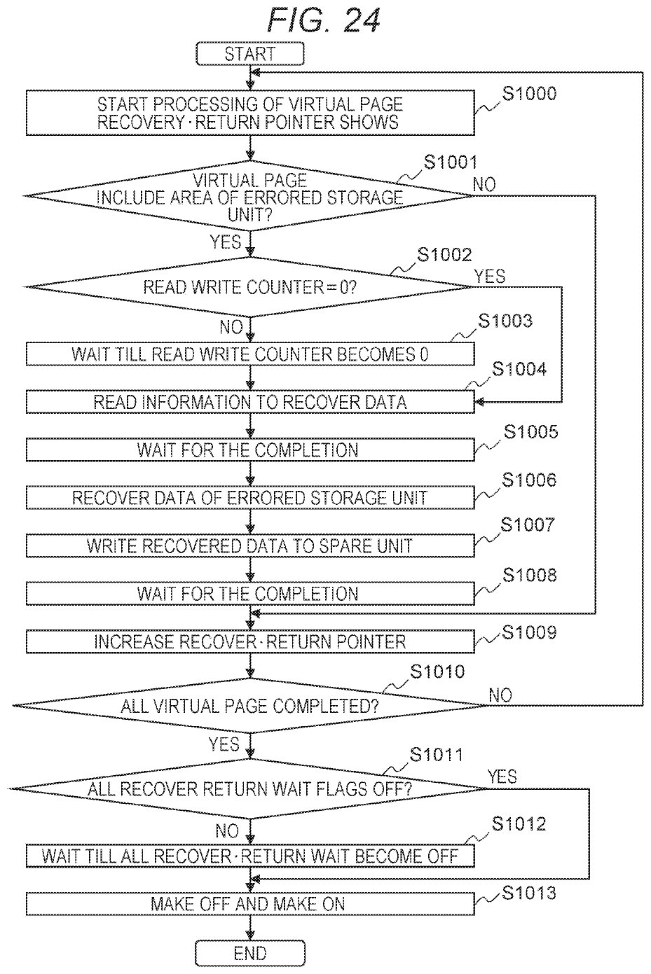

FIG. 24 is a flowchart for explaining an example of a spare data area recovery process that the spare data area recovery part 450 carries out. The spare data area recovery part 450 is provided for each logical volume.

At step S1000, the spare data area recovery part 450 sets a virtual page as a virtual page to be processed, the virtual page being indicated by the recovery/return pointer 2246 included in the logical volume information 224 of the logical volume.

At step S1001, the spare data area recovery part 450 specifies the storage group information 226 of a storage group including the virtual page, based on the storage group identifier 2271 included in the real page information 227 of the real page corresponding to the virtual page to be processed. Based on the specified storage group information 226, the spare data area recovery part 450 checks whether a storage unit 160 having a failure occurred is included in the storage group. The spare data area recovery part 450 executes a process of step S1002 when the storage unit 160 is included, and executes a process of step S1009 when the storage unit 160 is not included.

At step S1002, the spare data area recovery part 450 checks whether the value of the read/write counter 2247 corresponding to the virtual page to be processed, the read/write counter 2247 being in the logical volume information 224 of the logical volume, is 0. The spare data area recovery part 450 executes a process of step S1003 when the value of the read/write counter 2247 is not 0, and executes a process of step S1004 when the value of the read/write counter 2247 is 0.

At step S1003, the spare data area recovery part 450 stands by until the value of the read/write counter 2247 becomes 0.

At step S1004, to recover data stored in the storage unit 160 having the failure, the spare data area recovery part 450 issues a read request for data reading, to a storage unit storing data necessary for recovering the data.

At step S1005, the spare data area recovery part 450 stands by until the read request has been processed completely.

At step S1006, the spare data area recovery part 450 recovers the data stored in the storage unit 160 having the failure, based on the data acquired as a response to the read request.

At step S1007, the spare data area recovery part 450 issues a write request for writing recovered data, i.e., the data recovered, to a spare unit, based on the spare pointer 2266 of the specified storage group information 226.

At step S1008, the spare data area recovery part 450 stands by until the write request has been processed completely.

At step S1009, the spare data area recovery part 450 advances the recovery/return pointer 2246 of the logical volume information 224 of the logical volume, by 1.

At step S1010, based on the recovery/return pointer 2246, the spare data area recovery part 450 checks whether the recovery process on all areas of the logical volume is completed,. The spare data area recovery part 450 returns to the process of step S1000 when the recovery process is not completed, and proceeds to a process of step S1011 when the recovery process is completed.

At step S1011, the spare data area recovery part 450 checks whether the recovery/return wait flags 2274 of the real page information 227 of all empty real pages in the storage group including the storage unit having the failure are all off. The spare data area recovery part 450 executes a process of step S1012 when the recovery/return wait flags 2274 are not all off, and executes a process of step S1013 when the recovery/return wait flags 2274 are all off

At step S1012, the spare data area recovery part 450 stands by until the recovery/return wait flags 2274 of the entire real page information 227 turn off.

At step S1013, the spare data area recovery part 450 turns off the recovery flag 2245 of the logical volume information 224 of the logical volume, turns on the spare access flag 2249, and then ends the whole process flow.

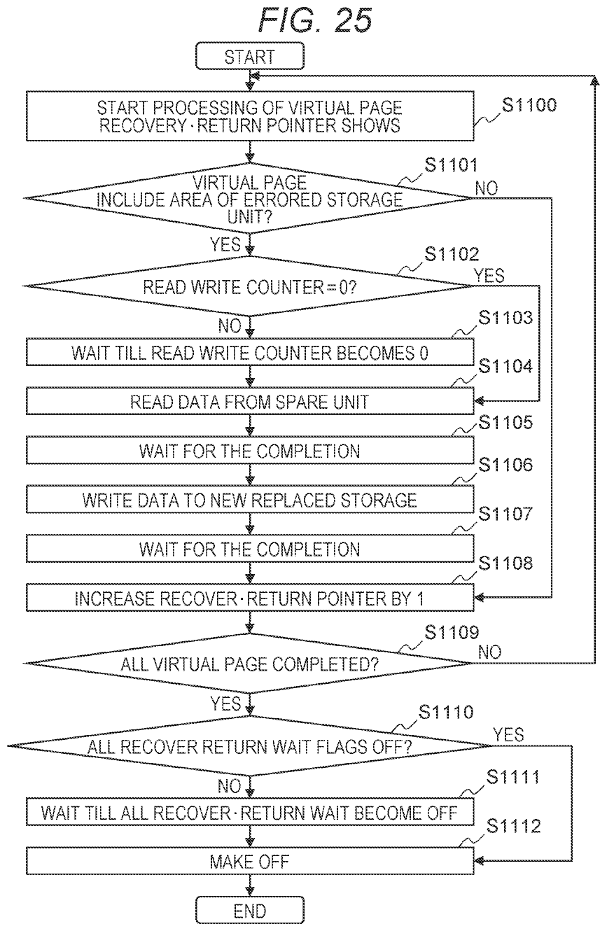

FIG. 25 is a flowchart for explaining an example of a data area returning process that the data area returning part 460 carries out. The data area returning process is executed at step S605. The data area returning part 460 is provided for each logical volume.

At step S1100, the data area returning part 460 sets a virtual page as a virtual page to be subjected to the returning process, the virtual page being indicated by the recovery/return pointer 2246 included in the logical volume information 224 of the logical volume.

At step S1101, the data area returning part 460 determines whether a new storage unit 160, i.e., replacing storage unit is included in a storage group indicated by the storage group identifier 2271 included in the real page information 227 of the real page corresponding to the virtual page to be processed. The replacing storage unit 160 is specified by, for example, the storage management server 130. The data area returning part 460 executes a process of step S1102 when the replacing storage unit 160 is included in the storage group, and executes a process of step S1108 when the storage unit 160 is not included in the storage group.

At step S1102, the data area returning part 460 checks whether the value of the read/write counter 2247 corresponding to the virtual page to be processed, the read/write counter 2247 being in the logical volume information 224 of the logical volume, is 0. The data area returning part 460 executes a process of step S1103 when the value of the read/write counter 2247 is not 0, and executes a process of step S1104 when the value of the read/write counter 2247 is 0.

At step S1103, the data area returning part 460 stands by until the value of the read/write counter 2247 becomes 0.

At step S1104, to return data to the replacing storage unit, the data area returning part 460 issues a read request for reading the data to be returned out of a spare unit storing that data.

At step S1105, the data area returning part 460 stands by until the read request has been processed completely.

At step S1106, the data area returning part 460 issues a write request for writing the data acquired as a response to the read request, to the replacing storage unit.

At step S1107, the data area returning part 460 stands by until the write request has been processed completely.

At step S1108, the data area returning part 460 advances the recovery/return pointer 2246 of the logical volume information 224 of the logical volume, by 1.

At step S1109, based on the recovery/return pointer 2246, the data area returning part 460 checks whether the returning process on all areas of the logical volume is completed. The data area returning part 460 returns to the process of step S1100 when the recovery process is not completed, and proceeds to a process of step S1010 when the recovery process is completed.

At step S1110, the data area returning part 460 checks whether the recovery/return wait flags 2274 of the real page information 227 of all empty real pages in the storage group including the replacing storage unit are all off. The data area returning part 460 executes a process of step S1111 when the recovery/return wait flags 2274 are not all off, and executes a process of step S1112 when the recovery/return wait flags 2274 are all off.

At step S1111, the data area returning part 460 stands by until the recovery/return wait flags 2274 of the real page information 227 of all empty real pages turn off.

At step S1112, the data area returning part 460 turns off the spare access flag 2249 of the logical volume information 224 of the logical volume, and ends the whole process flow.

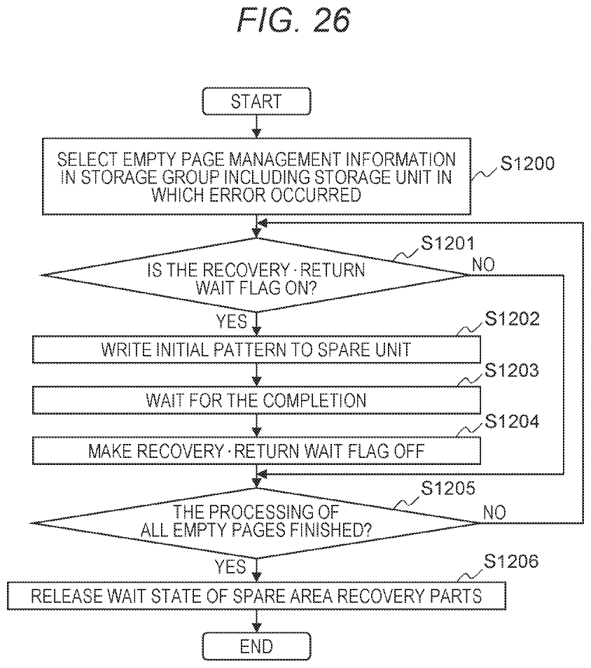

FIG. 26 is a flowchart for explaining an example of a spare empty area recovery process that the spare empty area recovery part 470 carries out. The spare empty area recovery process is executed at step S505 of FIG. 19.

At step S1200, the spare empty area recovery part 470 sets the real page information 227 as the real page information 227 to be subjected to the spare empty area recovery process, the real page information 227 being indicated by the empty real page information pointer 2263 of the storage group information 226 of a storage group including a storage unit 160 having a failure occurred.

At step S1201, the spare empty area recovery part 470 checks whether the recovery/return wait flag 2274 of the real page information 227 to be processed is on. The spare empty area recovery part 470 executes a process of step S1202 when the recovery/return wait flag 2274 is on, and executes a process of step S1205 when the recovery/return wait flag 2274 is off.

At step S1202, based on the spare pointer 2266 of the storage group information 226 corresponding to the storage group including the storage unit 160 having the failure, the spare empty area recovery part 470 issues a write request for writing initial data (initial pattern) to an area corresponding to a real page indicated by the real page information 227 to be processed, to a spare unit included in the storage group. It should be noted that the initial data is data stored in a storage area not allocated to a logical volume, and is, for example, data whose entire bits are 0.

At step S1203, the spare empty area recovery part 470 stands by until the write request has been processed completely.

At step S1204, the spare empty area recovery part 470 turns off the recovery/return wait flag 2274.

At step S1205, the spare empty area recovery part 470 checks whether the next real page information 227 indicating a real page in the empty state is present, based on the empty page pointer 2273 of the real page information 227 to be processed. When the next real page information 227 indicating the real page in the empty state is present, the spare empty area recovery part 470 selects the next real page information 227 as the real page information 227 to be processed, and returns to the process of step S1201. When the next real page information 227 indicating the real page in the empty state is not present, the spare empty area recovery part 470 executes a process of step S1206.

At step S1206, when the spare data area recovery part 450 in the standby state is present, the spare empty area recovery part 470 cancels the standby state of the spare data area recovery part 450 and ends the whole process flow.

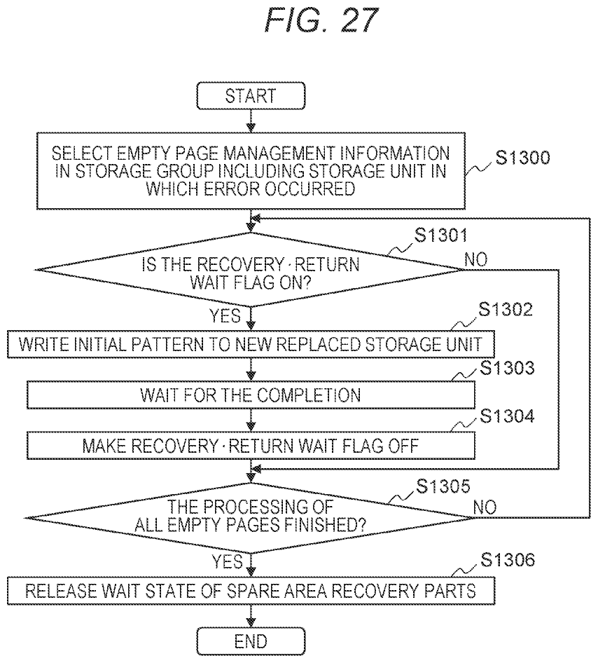

FIG. 27 is a flowchart for explaining an example of an empty area returning process that the empty area returning part 480 carries out. The empty area returning process is executed at step S605 of FIG. 20.

At step S1300, the empty area returning part 480 sets the real page information 227 as the real page information 227 to be processed, the real page information 227 being indicated by the empty real page information pointer 2263 of the storage group information 226 of a storage group including a new storage unit 160, i.e., replacing storage unit 160.

At step S1301, the empty area returning part 480 checks whether the recovery/return wait flag 2274 of the real page information 227 to be processed is on. The empty area returning part 480 executes a process of step S1302 when the recovery/return wait flag 2274 is on, and executes a process of step S1305 when the recovery/return wait flag 2274 is off.

At step S1302, the empty area returning part 480 issues a write request for writing initial data to an area corresponding to a real page indicated by the real page information 227 to be processed, to the replacing storage unit 160.

At step S1303, the empty area returning part 480 stands by until the write request has been processed completely.

At step S1304, the empty area returning part 480 turns off the recovery/return wait flag 2274.

At step S1305, the empty area returning part 480 checks whether the next real page information 227 indicating a real page in an empty state is present, based on the empty page pointer 2273 of the real page information 227 to be processed. When the next real page information 227 indicating the real page in the empty state is present, the empty area returning part 480 selects the next real page information 227 as the real page information 227 to be processed, and returns to the process of step S1301. When the next real page information 227 indicating the real page in the empty state is not present, the empty area returning part 480 executes a process of step S1306.

At step S1306, when the data area recovery part 460 in the standby state is present, the empty area returning part 480 cancels the standby state of the data area recovery part 460 and ends the whole process flow.

As described above, according to the present embodiment, the compound storage system (information system) includes the plurality of storage boxes 120 each having the plurality of storage units 160, and the plurality of real storage systems 100 that control the storage units 160. When a failure occurs at a storage unit 160, the real storage system 100 having the control right executes the recovery process of recovering data stored in a storage area allocated to a logical volume, and the real storage system 100 having the allocation authority executes the recovery process of recovering data stored in a storage area not allocated to the logical volume. The compound storage system, therefore, allows recovery of data stored in the storage unit 160 having the failure occurred.

According to the present embodiment, the real storage system 100 having the control right stores the recovered data in a spare unit. In this manner, in the compound storage system, the recovered data can be transferred to the spare unit. According to the present embodiment, when the storage unit 160 having the failure occurred is replaced with a new storage unit, the real storage system 100 having the control right transfers the recovered data from the spare unit to the new storage unit. In this manner, in the compound storage system, the data can be returned to the new storage unit, i.e., replacing storage unit.

According to the present embodiment, data stored in a real page not allocated to the logical volume is initial data. The compound storage system, therefore, allows recovery of initial data stored in the storage unit 160 having the failure.

According to the present embodiment, the real storage system 100 having the allocation authority stores the recovered initial data in the spare unit. In this manner, in the compound storage system, the recovered initial data can be transferred to the spare unit. According to the present embodiment, when the storage unit 160 having the failure occurred is replaced with a new storage unit, the real storage system 100 having the allocation authority transfers the recovered initial data from the spare unit to the new storage unit. In this manner, in the compound storage system, the initial data can be returned to the new storage unit, i.e., replacing storage unit.

### Second Embodiment

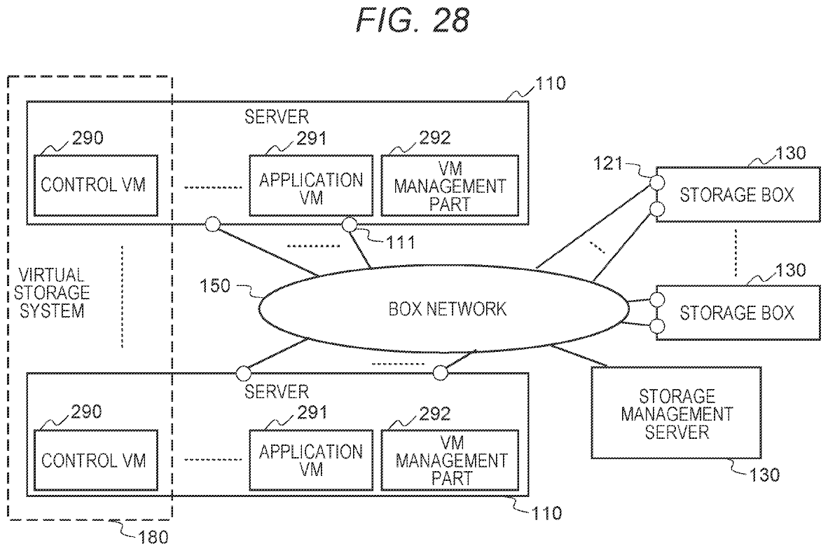

FIG. 28 depicts a configuration of an information system according to a second embodiment of the present disclosure. The information system shown in FIG. 28 is different from the information system shown in FIG. 1 in that the virtual storage system 180 is configured by the server 110. Specifically, the server 110 includes a control virtual machine (VM) 290 on which a storage controller runs, an application VM 291 on which a user application program runs, and a VM management unit 292 that manages the control VM 290 and the application VM 291.

In the example of FIG. 28, when the application VM 291 issues a read/write request, the control VM 290, which makes up the server 110 as the application VM does, receives the read/write request, and carries out a process according to the read/write request. For example, the control VM 290 issues a read/write request to the storage box 120 via the box network 150, and exchanges read/write data with the storage box 120. In addition, the control VM 290 communicates with the control VM 290 included in a different server 110, via the box network 150.

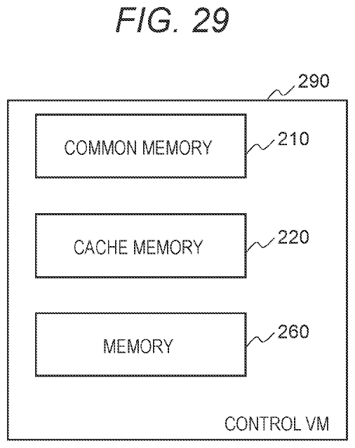

FIG. 29 depicts an example of memory resources used by the control VM 290. A main storage unit of the server 110 allocates a shared memory 220, a cache memory 210, and a memory 260 to the control VM 290.

In the case of the present embodiment, the control VMs 290 make up the virtual storage system 180, and each of the control VMs 290 carries out the same process as the real storage system 180 (specifically, the storage controller 200 of the real storage system 180) of the first embodiment does. The second embodiment, therefore, allows execution of the same processes as executed in the first embodiment, thus offering the same effects as the first embodiment offers.

Each of the above embodiments according to the present disclosure is an exemplary embodiment for describing the present disclosure, and is not intended to limit the scope of the present disclosure to those embodiments. Those skilled in the art are allowed to implement the present disclosure in various different modes without departing from the scope of the present disclosure.

What is claimed is:

1. A compound storage system comprising:
a plurality of storage units; and
a plurality of storage systems each of which provides a logical volume, the storage system processing data inputted to and outputted from the storage units, via the logical volume, wherein
a storage area of each of the storage units is allocated to the logical volume,
a control right is allocated to one of the storage systems, the control right being an authority to input and output data to and from the logical volume,
an allocation authority is allocated to one of the storage systems, the allocation authority being an authority to allocate the storage area of the storage unit to the logical volume, and
when a failure occurs at the storage unit, a storage system having the control right executes a recovery process of recovering data stored in the storage area allocated to the logical volume, while a storage system having the allocation authority executes a recovery process of recovering data stored in the storage area not allocated to the logical volume.

2. The compound storage system according to claim 1, wherein a storage system having the control right writes recovered data that is the data recovered, to a spare unit that is a storage unit different from a storage unit having the failure occurred.

3. The compound storage system according to claim 2, wherein when a storage unit having the failure occurred is replaced with a new storage unit, a storage system having the control right transfers the recovered data from the spare unit to the new storage unit.

4. The compound storage system according to claim 1, wherein data stored in a storage area not allocated to the logical volume is initial data.

5. The compound storage system according to claim 4, wherein a storage system having the allocation authority writes recovered initial data that is the initial data recovered, to a spare unit that is a storage unit different from a storage unit having the failure occurred.

6. The compound storage system according to claim 5, wherein when a storage unit having the failure occurred is replaced with a new storage unit, a storage system having the allocation authority transfers the recovered initial data from the spare unit to the new storage unit.

7. A control method for a compound storage system including a plurality of storage units and a plurality of storage systems each of which provides a logical volume, the storage system processing data inputted to and outputted from the storage units, via the logical volume, the control method comprising:
allocating a storage area of each of the storage units to the logical volume;
allocating a control right to one of the storage systems, the control right being an authority to input and output data to and from the logical volume; and
when a failure occurs at the storage unit, causing a storage system having the control right to execute a recovery process of recovering data stored in the storage area allocated to the logical volume, while causing a storage system having the allocation authority to execute a recovery process of recovering data stored in the storage area not allocated to the logical volume.
